(19) United States
(12) Patent Application Publication
(10) Pub. No.: US 2024/0279778 A1
(43) Pub. Date: Aug. 22, 2024

(54) ALUMINUM ALLOY PLATE SHEET FOR PARALLELEPIPED BATTERY HOUSING

(71) Applicant: CONSTELLIUM ROLLED PRODUCTS SINGEN GMBH & CO.KG, Singen (DE)

(72) Inventors: Emilie LAE, Saint Jean de Moirans (FR); Mathilde BOUCHARD, Brandenburg an Der Havel (DE)

(21) Appl. No.: 18/567,588

(22) PCT Filed: Jun. 1, 2022
(86) PCT No.: PCT/EP2022/064919

§ 371 Date: Dec. 6, 2023

(30) Foreign Application Priority Data
Jun. 11, 2021 (FR) 2106190

(51) Int. Cl. C22C 21/00; C22F 1/04; H01M 50/103

(52) U.S. Cl. CPC C22C 21/00; C22F 1/04; H01M 50/103

(57) ABSTRACT

The invention concerns a method to make an aluminium alloy sheet product wherein successively, a slab is cast of an aluminium alloy comprising, by weight % Mn: 0.9-1.2, Fe: 0.5-0.8, Si: 0.05-0.25, Cu: 0.06-0.20, Ti: ≤0.1, and by ppm, Mg: <100, Zn: <100, B: <200, Sn: <100, Bi: <100, Cr: ≤100, other impurities <500 each and <1500 total, remainder aluminium, the slab is homogenized at a temperature of at least 610° C. and preferably of at least 615° C., the homogenized slab is hot rolled and cold rolled into a sheet, which is optionally thermally treated and/or tension leveled. The aluminium alloy sheet product of the invention are useful in particular to make parallelepiped battery housing.

### FIELD OF THE INVENTION

The invention relates to an aluminum alloy plate sheet for a parallelepiped battery housing, particularly for electric vehicles, and a preparation method thereof.

### STATE OF THE ART

In recent years, as automobile exhaust gas regulations in many countries become severe, the production of electric vehicles as environment-responsive vehicle is rapidly extending. A secondary battery is used in the electric vehicle and the current mainstream is the lithium ion battery. Among shapes used for the battery housing, parallelepiped shapes are particularly useful due to packing facilities. Indeed, shapes with a rectangular or square cross-section are easily packed in a battery box.

Conventionally, a housing for a secondary battery is manufactured by press forming (deep drawing and possibly ironing) an aluminum alloy sheet as a raw material. The battery has a structure in which electrodes, a separator, an electrolyte solution, and the like are sealed by the housing and a lid, and the housing and the lid made of aluminum or an aluminum alloy are joined by laser welding.

Housing for a secondary battery has been widely used for portable electronic devices such cell phones and laptop computers. As the portable electronic devices were miniaturized, the size and weight were reduced and the height of the housing was reduced. For applications in electric cars the size is higher and new challenges were encountered. In particular, the aluminum sheet or aluminum alloy sheet for battery cases is required in particular to have good press formability and laser weldability, which are characteristics required for production, and also to have good strength and durability after the case is produced. The strength, durability such as not expanding even after long-term use of the housing, not easy deformation by external force, resistance to perforation are properties needed for battery housing.

The patent application CN112195373 A discloses an aluminum alloy strip for a battery shell having a chemical composition Fe 0.55-0.75%, Si 0.20-0.40%, Cu 0.08-0.10%, Mn 0.95-1.15%, ΔTi 0.015-0.020%. Delta Ti is the content difference value of Ti in a launder and a standing furnace. The manufacturing method comprises the steps of smelting and refining; continuous casting and rolling; double-stage desolventizing annealing; and cold rolling. The alloy cooling solidification speed in the continuous casting and rolling process is effectively reduced, the solid solution amount of Mn in the alloy is reduced, segregation and unbalanced crystalline structures are eliminated, fine grain structures are formed in the alloy, and the distribution uniformity of alloy elements is improved; and the tensile strength of a finished product of the prepared aluminum alloy strip ranges from 140 MPa to 165 MPa, the yield strength is larger than or equal to 130 MPa, the ductility is larger than or equal to 8%, and the mechanical property is excellent.

The patent application CN109666822 A discloses a 3003-H14 aluminum alloy for battery case. The preparation method includes the following steps of casting, sawing, soaking, milling, heating, hot rolling, cold rolling and annealing. In the casting step, a cast ingot comprises, by mass, 0-0.3% of Si, 0.5%-0.6% of Fe, 0-0.1% of Cu, 1.1%-1.4% of Mn, 0-0.05% of Zn, 0.01%-0.03% of Ti, 0-0.02% of other impurity individuals, 0-0.10% of other total impurities and the balance Al after casting. By adoption of the production preparation method, it is guaranteed that the mechanical properties of the 3003-H14 aluminum alloy battery case material are stable and qualified, anisotropy is balanced in stamping, and the stamping properties are good.

The patent application CN111647775 A discloses an aluminum alloy for battery shell having components in percentage by weight: 0.17 to 0.30% of Si, 0.50 to 0.60% of Fe, 0.02 to 0.08% of Cu, 0.90 to 1.05% of Mn, 0.02 to 0.06% of Mg, less than or equal to 0.05%, 0.015 to 0.04% of Ti, and the balance of Al and the unavoidable impurities with the single element of less than or equal to 0.05% and the total amount of less than 0.15%. The aluminum alloy provided by the invention has good plastic deformation capacity, and can meet the requirement on deep drawability and the requirement on surface quality of the battery shell.

The patent application CN110983115 A discloses a 3003 aluminum alloy strip material comprises the following components, in percentage, of 0.5%-0.7% of Si, 0.6%-0.8% of Fe, 0.05%-0.2% of Cu, 1.0%-1.5% of Mn, 0%-0.02% of Mg, 0%-0.02% of Zn, less than 0.03% of Mg+Zn, the balance Al and inevitable impurities.

The patent application CN110453110 A discloses an aluminum alloy strip material comprises, by mass, 0.07 wt %-0.25 wt % of Si, 0.35 wt %-0.70 wt % of Fe, 0.05 wt %-0.20 wt % of Cu, 1.0 wt %-1.5 wt % of Mn, 0.015 wt %-0.2 wt % of Sn, 0.015 wt %-0.2 wt % of Bi, smaller than or equal to 0.02 wt % of Mg, smaller than or equal to 0.03 wt % of Zn, 0.03 wt %-0.05 wt % of Ti, smaller than or equal to 0.05 wt % of Zr and the balance Al and inevitable impurities, wherein the ratio of Fe to Si is equal to 2 to 4.

The patent application CN108559878 A discloses an aluminum alloy plate strip for the battery shell comprises chemical components including, by mass percent, 0.2% or less of Si, 0.5%-0.6% of Fe, 0.05%-0.10% of Cu, 0.06%-1.15% of Mn, 0.03% or less of Mg, 0.03% or less of Zn, 0.02%-0.04% of Ti, 0.15% or less of unavoidable impurity elements and the balance Al. Grains of the aluminum alloy plate strip can be uniform, the diameters of the grains can be smaller than 50 microns, and the extension strength, the yield strength, the ductility and other normal temperature physical performance of the aluminum alloy plate strip are guaranteed.

The patent application CN111074110 A discloses a production method of aluminum and aluminum alloy plates and strips for a new energy power battery case. The method comprises the following steps of aluminum melt preparing, continuous casting and rolling, homogenizing annealing, cold rolling, intermediate annealing or final annealing. The method can be used for producing 3003 alloy plate and strip products in the states of“O”, “H12” and “H14” for the new energy power battery case, and the strength and the yield ratio of material of the obtained products can be effectively enhanced.

The patent application JP11350057 A discloses an Al—Mn alloy sheet Mn 0.8-2%, Si 0.04-0.2%, Fe 0.4-0.6%, Cu 0.05-0.25%, Cr 0.02-0.1%.

The patent application JP2002294379 A discloses an alloy sheet having a composition containing, by mass, 0.05 to 0.3% Cu, 0.05 to 0.8% Mg, 0.6 to 1.5% Mn and either or both of Si and Fe by 0.1 to 1.0%, and the balance Al with inevitable impurities, and has proof stress of 240 to 320 MPa. Further, this aluminum alloy is hot-rolled, and is thereafter cold-rolled at a rolling ratio of >=75% as it is.

The patent application JP2012082506 A discloses an aluminum-alloy sheet for the battery case, is composed of, by mass %, 0.8-1.5% Mn, 0.05-0.2% Cu, 0.05-0.6% Si, 0.05-0.7% Fe, ≤0.05% Zn, ≤0.05% Mg, <0.04% Ti and B regulated to <10 ppm and the balance Al with inevitable impurities. Even when the penetration depth of the laser beam is ≥0.25 mm which is deep, the occurrence of the irregular bead can be prevented.

The patent application US20150368771 A discloses an aluminum alloy for producing semi-finished products or components for motor vehicles is provided, wherein the alloying components of the aluminum alloy have the following contents in percent by weight: Fe≤0.80%, Si≤0.50%, 0.90%≤Mn≤1.50%, Mg≤0.25%, Cu≤0.125%, Cr≤0.05%, Ti≤0.05%, V≤0.05%, Zr≤0.05%, the remainder being aluminum, unavoidable impurity elements, individually <0.05%, in total <0.15%, and the combined content of Mg and Cu satisfies the following relation in percent by weight: 0.15%≤Mg+Cu≤0.25%, wherein the Mg content of the aluminum alloy is greater than the Cu content of the aluminum alloy.

To further improve the manufacturing of battery housing, it is needed to minimize the metal loss during manufacturing of the large size battery housing and to ensure even metal thickness distribution in the part walls. This is particularly relevant for recent battery housing for electric vehicles which have a large size compared to those of the prior art.

### The Problem

The problem that the present invention solves is to obtain an improved sheet for large sized parallelepiped battery housing, having good drawability and laser weldability with sufficient strength and thermal stability, enabling to minimize the metal loss during manufacturing of large size battery housing and ensuring even metal thickness distribution in the part walls.

### SUBJECT OF THE INVENTION

A first subject of the invention is a method to make an aluminium alloy sheet product comprising successively,
(a) a slab is cast of an aluminium alloy comprising, by weight %
Mn: 0.9-1.2,
Fe: 0.5-0.8,
Si: 0.05-0.25,
Cu: 0.06-0.20,
Ti: ≤0.1,
and by ppm,
Mg: <100,
Zn: <100,
B: <200,
Sn: <100,
Bi: <100,
Cr: ≤100,
other impurities <500 each and <1500 total, remainder aluminium,
(b) the slab is homogenized at a temperature of at least 610° C. and preferably of at least 615° C.,
(c) the homogenized slab is hot rolled to an intermediate hot rolled product having a thickness from 2 to 10 mm, with a first hot rolling step on a reversible mill,
(d) the intermediate rolled product is cold rolled into a sheet, optionally with an intermediate annealing during cold rolling,
(e) the sheet is optionally thermally treated at a temperature from 150° C. to 350° C.,
(f) optionally the sheet undergoes tension leveling with a stretching of at least 0.3%.

A second subject of the invention is an aluminium alloy sheet product made according to the method of the invention,

Yet another subject of the invention is the use of an aluminium alloy sheet product according to the invention to make a parallelepiped battery housing with a height of at least 70 mm, a length of at least 100 mm and a width of at least 15 mm.

### DESCRIPTION OF THE INVENTION

Unless otherwise indicated, all indications concerning the chemical composition of alloys are expressed as a percentage by weight based on the total weight of the alloy. The expression 1.4 Cu means that the copper content expressed in % by weight is multiplied by 1.4. The designation of the alloys is made in accordance with the regulations of The Aluminium Association, known to those skilled in the art.

The static mechanical properties in tension, in other words the ultimate tensile strength UTS, the conventional yield strength at 0.2% elongation TYS (tensile yield strength), and the elongation at break A %, are determined by a tensile test according to standard NF EN ISO 6892-1. The elongation (A %) at break was measured using a 50 mm base extensometer and is reported under A50. Unless stated otherwise, the definitions of standard EN 12258 (2012) apply.

Earing percentage is measured according to standard DIN EN 1669. A sheet is a rolled product with a rectangular cross section, the uniform thickness of which is from 0.20 mm to 6 mm. In the context of the invention, a sheet is not a clad sheet. A preferred thickness of the sheet of the invention is from 0.5 mm to 1.5 mm and more preferably from 0.7 mm to 1.3 mm.

Unless otherwise mentioned, the tempers defined in standard EN 515 (2017) apply.

The inventors have found an aluminium alloy sheet product composition and manufacturing method which solves the problem. The inventors found in particular an aluminium alloy sheet product composition and manufacturing method which enable to obtain a tensile yield strength of typically at least 115 MPa, an ultimate tensile strength of typically at least 135 MPa an elongation of at least 5%, which is thermally stable at 180° C. for at least 30 min, has superior weldability and drawability and which minimizes the metal loss during manufacturing of large size battery housing and ensures even metal thickness distribution in the part walls.

In particular, in order to optimize the metal loss during manufacturing and ensure even metal thickness distribution in the part walls of the large size battery housing, the present inventors found an aluminium alloy sheet product having low anisotropy of mechanical properties and low earing percentage. Indeed, as a result of different radial elongations in different directions of the sheet, undesired wavy cup rims form during deep drawing, which is called earing. The highest parts are called ear peaks, while the lowest regions are called ear valleys. Earing formation, which is related to texture and mechanical properties, results from a complex combination between composition and processing. With low earing percentage, the metal loss during manufacturing of large size battery housing is minimized. The inventors observed also that low earing percentage enables to ensure even metal thickness distribution in the part walls of the large size battery housing.

Mn is used to improve strength. The Mn content is from 0.9 to 1.2 wt. %. Preferably the minimum Mn content is 0.94 wt. %, more preferably 0.95 wt. % and preferentially 0.96 wt. %. Preferably the maximum Mn content is 1.15 wt. % and more preferably 1.10 wt. % and preferentially 1.08 wt. %. In a preferred embodiment by wt. %, Mn: 0.95-1.15 and preferably Mn: 0.96-1.07. In an embodiment, which is favorable for earing behavior in particular in association to reduced cold working, by wt. %, Mn: 1.00-1.15 and preferably 1.01-1.10.

Fe influences the earing behavior. The Fe content is from 0.5 to 0.8 wt. %. Preferably the minimum Fe content is 0.55 wt. %, more preferably 0.58 wt. %, preferentially 0.60 wt. % more preferentially 0.62 wt. %. Preferably the maximum Fe content is 0.75 wt. % and more preferably 0.72 wt. % and preferentially 0.70 wt. %. In a preferred embodiment by wt. %, Fe: 0.60-0.70 and preferably Fe: 0.62-0.68. In an embodiment the Fe content is from 0.62 to 0.8 wt. %.

Si also influences the earing behavior. The Si content is from 0.05 to 0.25 wt. %. Preferably the minimum Si content is 0.07 wt. %, more preferably 0.10 wt. % and preferentially 0.11 wt. %. Preferably the maximum Si content is 0.22 wt. % and more preferably 0.20 wt. % and preferentially 0.18 wt. %. In a preferred embodiment by wt. %, Si: 0.10-0.20 and preferably Si: 0.12-0.18.

It is also important that with the selected preferred Fe and Si contents recyclability of the alloy is quite satisfactory.

Cu is added to improve strength. The Cu content is from 0.06 to 0.20 wt. %. Preferably the minimum Cu content is 0.08 wt. %, more preferably 0.10 wt. %, or even more preferably 0.13 wt. %. Preferably the maximum Cu content is 0.18 wt. % and more preferably 0.17 wt. %. In a preferred embodiment, by wt. %, Cu: 0.11-0.18 and preferably Cu: 0.13-0.17, the inventors found that this preferred Cu range is particularly useful for sheets in a H14 temper, because it enables specific process steps such as reduced cold rolling after intermediate annealing that improves earing behavior.

The Ti content is limited to a maximum of 0.1 wt. %. Ti may be added to improve grain size control, in particular during casting. In an embodiment the Ti content is at least 0.01 wt. %. Preferably the maximum Ti content is 0.08 wt. % and more preferably 0.05 wt. %.

Boron is often added in association to titanium. Boron is limited to less than 200 ppm. Preferably, the B content is less than 150 ppm, more preferably less than 100 ppm and even more preferably less than 50 ppm. Addition of boron is favorable for the combination of properties of the alloy. Preferably the minimum B content is 5 ppm, more preferably 7 ppm, or even more preferably 10 ppm or 11 ppm. In an embodiment the B content is 10-50 ppm.

The Zn and Mg contents are less than 100 ppm in order to obtain sufficient laser weldability. Preferably, the Zn content is less than 90 ppm, more preferably less than 80 ppm and even more preferably less than 60 ppm. Preferably, the Mg content is less than 80 ppm, more preferably less than 50 ppm and even more preferably less than 20 ppm.

The Sn and Bi contents are less than 100 ppm in particular because Bi is detrimental to surface oxidation and Sn is detrimental for corrosion resistance. Preferably, the Sn content is less than 90 ppm, more preferably less than 80 ppm and even more preferably less than 60 ppm. Preferably, the Bi content is less than 80 ppm, more preferably less than 50 ppm and even more preferably less than 20 ppm.

The Cr content is less than 100 ppm to avoid primary crystals during casting. Preferably, the Cr content is less than 80 ppm, more preferably less than 50 ppm and even more preferably less than 20 ppm.

Other elements are impurities whose content is less than 500 ppm each and 1500 ppm total. Preferably the content of other elements is less than 150 ppm each and 500 ppm total.

The method to make an aluminium alloy sheet product according to the invention comprises casting a slab with a composition according to the invention, homogenizing, hot and cold rolling the slab, optionally annealing and tension leveling.

The slab is homogenized at a temperature of at least 610° C., preferably of at least 615° C. and more preferably of at least 620° C. The maximum homogenizing temperature is defined to avoid incipient melting, it is typically 640° C. or 630° C. Preferably, the homogenization is carried out during at least one hour, advantageously at least 5 hours, more preferably at least 10 hours. Homogenization longer than 50 hours or even 30 hours do not provide further improvement. The present inventors found that the homogenization conditions of the invention are particularly favorable for the balance between the properties of the sheet of the invention, in particular the homogenization conditions enable to reduce earing percentage. Before or after homogenization, the slab is usually scalped.

The homogenized slab is then hot rolled to an intermediate rolled product having a thickness from 2 to 10 mm. The hot rolling starts, in a first hot rolling step, with hot rolling on at least one reversible mill, or roughing mill. During rolling on reversible mill, the hot rolling temperature is at least 400° C. and preferably at least 410° C. The hot rolling conditions on reversible mill are adjusted to obtain a hot rolled product having, after rolling on reversible mill, a volume fraction of recrystallized grains of at least 50%, preferably of at least 80% and more preferably of 100%. The hot rolling conditions on reversible mill of the invention are also favorable for the balance between the properties of the sheet of the invention, and also contribute to reduce the earing percentage. In an optional second hot rolling step after reversible mill, the product may be further hot rolled on a tandem mill.

The intermediate rolled product is then cold rolled into a sheet, optionally with an intermediate annealing during cold rolling.

The sheet is then optionally thermally treated at a temperature from 150° C. to 350° C. and optionally the sheet undergoes tension leveling with a stretching of at least 0.3%.

The optional thermal treatment at a temperature from 150° C. to 350° C. may be an annealing, a partial annealing or a stabilization heat treatment.

In a first embodiment, which corresponds typically to a H1X temper, preferably a H14 temper, the intermediate rolled product is first cold rolled to a first thickness from 0.8 to 2.0 mm, then annealed at a temperature from 300° C. to 450° C. and then cold rolled to a second thickness from 0.5 mm to 1.5 mm. The second cold reduction is typically from 15% to 25%, preferably from 16% to 23%. It is advantageous to add Cu in the range, by wt. %, 0.11-0.18 and preferably Cu: 0.13-0.17 and/or Mn in the range by wt. %, Mn: 1.00-1.15 and preferably 1.01-1.10 and/or to reduce the second cold reduction to preferably from 17% to 21% and more preferably from 18 to 20%, in order to improve drawing ability with improved elongation and low earing percentage. The second cold reduction is designed to obtain an ultimate tensile strength which is approximately midway between that of the O temper and that of the hardest temper (H18 or H19). Optionally a stabilization heat treatment may be carried out at a temperature from 150° C. to 200° C. after the second cold rolling.

In a second embodiment, which corresponds to a H2X temper, preferably a H24 temper, the intermediate rolled product is directly cold rolled, i. e. without any intermediate annealing, into a sheet with a thickness from 0.5 mm to 1.5 mm and then partially annealed. The sheet is partially annealed at a temperature from 250° C. to 350° C. preferably from 260° C. to 300° C. The partial annealing is designed to obtain an ultimate tensile strength is approximately midway between that of the O temper and that of the hardest temper (H18 or H19).

Optionally, the sheet may finally undergo tension leveling with a stretching of at least 0.3% and preferably at least 0.5%. Tension leveling may be needed to improve flatness of the product.

The sheets of the invention have preferably, in the longitudinal direction, a TYS of at least 115 MPa and preferably of at least 125 MPa, an elongation A % of at least 5% and a UTS from 135 to 185 MPa and preferably from 140 to 180 MPa. The sheets of the invention have more preferably, in the longitudinal direction, a TYS of at least 135 MPa, an elongation A % of at least 7% and a UTS from 145 to 180 MPa.

Preferably in the H14 temper, the sheets of the invention have, in the longitudinal direction, a TYS of at least 125 MPa and preferably at least 135 MPa, an elongation A % of at least 6%, preferably an elongation A % of at least 7%, and a UTS from 140 to 185 MPa and preferably from 145 to 180 MPa and an earing percentage lower than 7% and preferably lower than 5%.

Preferably in the H24 temper, the sheets of the invention have, in the longitudinal direction, a TYS of at least 125 MPa and preferably at least 135 MPa, an elongation A % of at least 11% and a UTS from 140 to 185 MPa and preferably from 145 to 180 MPa and an earing percentage lower than 12%. H24 temper enable a more complex drawing process.

The sheet according to the invention is preferably used to make a parallelepiped battery housing with a height of at least 70 mm, a length of at least 100 mm and a width of at least 15 mm and preferably with a height of at least 80 mm, a length of at least 120 mm and a width of at least 20 mm and even more preferably with a height of at least 90 mm, a length of at least 140 mm and a width of at least 25 mm. With such a size, the sheets of the invention which are formable and have low earing percentage are particularly advantageous.

The details of the invention will be understood better with the help of the example below, which is not, however, restrictive in its scope.

### EXAMPLE

### Example 1

The alloys disclosed in Table 1 where cast in the form of ingots.

TABLE 1
Composition of the tested alloys

| | | | | | | | | | | other | |
|---|---|---|---|---|---|---|---|---|---|---|---|
| | Si | Fe | Cu | Mn | Mg | Cr | Zn | Ti | B | elements (ppm) | |
| Alloy | (wt %) | (wt %) | (wt %) | (wt %) | (ppm) | (ppm) | (ppm) | (ppm) | (ppm) | each | total |
| A | 0.14 | 0.66 | 0.15 | 0.98 | 5 | 13 | 54 | 207 | 10 | ≤150 | ≤500 |
| B | 0.14 | 0.62 | 0.08 | 0.99 | 6 | 19 | 39 | 237 | 11 | ≤150 | ≤500 |
| C | 0.13 | 0.64 | 0.06 | 1.05 | 5 | 12 | 30 | 276 | 11 | ≤150 | ≤500 |
| D | 0.16 | 0.64 | 0.15 | 1.07 | 6 | 13 | 39 | 251 | 14 | ≤150 | ≤500 |

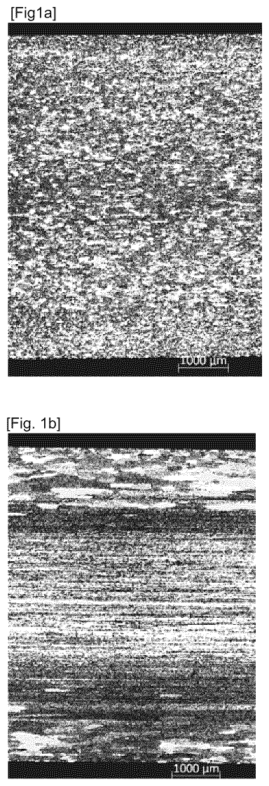

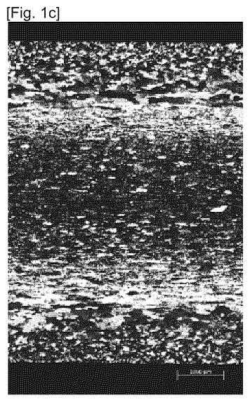

The ingots were scalped and homogenized with different conditions as illustrated by Table 2. Examples 2 and 3 are reference examples. After reheating at 490° C., the ingots were hot rolled on a reversible mill at a temperature remaining higher than 400° C., down to a thickness from 6 to 8 mm. The exit hot rolling temperature on the reversible mill and the hot rolling final thickness are provided in Table 2. The microstructure was characterized after reversible hot rolling for examples 2, 4 and 6. The microstructures are presented in [FIG. 1a], [FIG. 1b] and [FIG. 1c] for examples 4, 2 and 6, respectively. For example 2, the volume fraction of recrystallized grains was 20%, for example 4, the volume fraction of recrystallized grains was 100% and for example 6 the volume fraction of recrystallized grains was 50%.

Sheets in a H14 temper were prepared as follows: cold rolling with about 80% reduction to an intermediate thickness, intermediate annealing of 3 hours at 345° C. and final cold rolling with the cold reduction disclosed in Table 2. Sheets in a H24 temper were prepared as follows: cold rolling down to the final thickness and final annealing to the H24 temper, with the conditions disclosed in Table 2.

TABLE 2
Transformation process

| | | | | | Hot | | | |
|---|---|---|---|---|---|---|---|---|
| | | | | Hot | Rolling | | | |
| | | | | Rolling | Exit | Final cold | | final |
| | | | | Exit Temp | Thickness | reduction | Annealing | thickness |
| Example | Alloy | Temper | Homogenization | (° C.) | (mm) | % (H14) | (H24) | [mm] |
| 1 | A | H24 | 17 h | 435 | 6.9 | | (280° C., 1 h) | 1.0 |
| | | | 620° C. | | | | | |
| 2 | B | H24 | 3 h | 433 | 6.9 | | (285° C., 1 h) | 1.0 |
| | | | 600 C. ° | | | | | |
| 3 | B | H24 | 3 h | 434 | 6.9 | | (285° C., 1 h) | 1.0 |
| | | | 600° C. | | | | | |
| 4 | B | H24 | 17 h | 424 | 6.9 | | (295° C., 1 h) | 1.0 |
| | | | 620° C. | | | | | |
| 5 | B | H24 | 17 h | 438 | 7.0 | | (285° C., 1.5 h) | 1.2 |
| | | | 620° C. | | | | | |
| 6 | C | H24 | 4 h | 425 | 6.9 | | na | 1.2 |
| | | | 615° C. | | | | | |
| 7 | C | H24 | 17 h | 420 | 6.9 | | (280° C., 1 h) | 1.1 |
| | | | 620° C. | | | | | |
| 8 | A | H14 | 17 h | na | 6.8 | 21 | | 1.0 |
| | | | 620° C. | | | | | |
| 9 | D | H14 | 17 h | 427 | 6.0 | 19 | | 1.0 |
| | | | 620° C. | | | | | |
| 10 | D | H14 | 17 h | 427 | 6.0 | 19 | | 1.2 |
| | | | 620° C. | | | | | |

The anisotropy of the material at final temper is assessed by measuring the earing percentage of deep drawn 33 mm diameter round cups with 20 mm height (3 cups per case), according to the DIN EN 1669 standard. The four ear peaks are localized at angles of 45°, 135°, 225° and 315° vs the rolling direction. The earing percentage is calculated as hₑ/h*100, where hₑ is the mean height of ear and h is the mean cup height. The mechanical properties are measured in the longitudinal direction L.

The results are provided in Table 3.

TABLE 3
Mechanical properties of the sheets

| | earing | | | |
|---|---|---|---|---|
| | percentage | YS | UTS | A50 |
| Example | [%] | [MPa] | [MPa] | [%] |
| 1 | 9.6 | 152 | 167 | 15.2 |
| 2 | 14.1 | 156 | 163 | 16.6 |
| 3 | 13.1 | 147 | 160 | 16.1 |
| 4 | 8.9 | 145 | 160 | 15.4 |
| 5 | 7.0 | 125 | 149 | 18.8 |
| 6 | 11 | X | X | X |
| 7 | 8.5 | 148 | 159 | 16.2 |
| 8 | 4.3 | 149 | 154 | 7.2 |
| 9 | 4.1 | 140 | 148 | 11.5 |
| 10 | 3.5 | 139 | 149 | 11.3 |

### Example 2

In this example, the cold rolling second step needed to reach a minimum tensile yield strength of 140 MPa in the H14 temper was calculated with an internal metallurgical model in order to evaluate the effect of Cu. The homogenization was at 620° C. and the reheating at 490° C. The composition of the alloys is provided in Table 4

TABLE 4
Composition of the alloys

| | Si | Fe | Cu | Mn |
|---|---|---|---|---|
| Alloy | (wt %) | (wt %) | (wt %) | (wt %) |
| E | 0.15 | 0.65 | 0.05 | 1.0 |
| F | 0.15 | 0.65 | 0.10 | 1.0 |
| G | 0.15 | 0.65 | 0.15 | 1.0 |

The minimum cold rolling deformation needed to obtain a longitudinal tensile yield strength of 140 MPa was 40% for alloy E, 29% for alloy F and 23% for alloy G.

A lower cold rolling is advantageous to reduce the earing percentage. Indeed, the cold rolling will increase the deformation texture level and grow the 45° ears that are already present after intermediate annealing. Adding 0.15 wt. % Cu is thus advantageous in the H14 temper.

1. A method to make an aluminum alloy sheet product comprising successively,
(a) casting a slab of an aluminum alloy comprising, by weight %
Mn: 0.9-1.2,
Fe: 0.5-0.8,
Si: 0.05-0.25,
Cu: 0.06-0.20,
Ti: ≤0.1,
and by ppm,
Mg: <100,
Zn: <100,
B: <200,
Sn: <100,
Bi: <100,
Cr: ≤100,
other impurities <500 each and <1500 total, remainder aluminum,
(b) the slab is homogenized at a temperature of at least 610° C.,
(c) the homogenized slab is hot rolled to an intermediate hot rolled product having a thickness from 2 to 10 mm, with a first hot rolling on a reversible mill,
(d) the intermediate rolled product is cold rolled into a sheet, optionally with an intermediate annealing during cold rolling,
(e) the sheet is optionally thermally treated at a temperature from 150° C. to 350° C.
(f) optionally the sheet undergoes tension leveling with a stretching of at least 0.3%.

2. A method according to claim 1 wherein the slab is homogenized at a temperature of at least 615° C.

3. A method according to claim 1 wherein Cu: 0.11-0.18 wt. % and optionally Cu: 0.13-0.17 wt. %.

4. A method according to claim 1 wherein Fe: 0.62-0.8 wt. %.

5. A method according to claim 1 wherein the maximum Mn content is 1.08 wt. %.

6. A method according to claim 1 wherein in d the intermediate rolled product is first cold rolled to a first thickness from 0.8 to 2.0 mm, then annealed at a temperature from 300° C. to 450° C. and then cold rolled to a second thickness from 0.5 mm to 1.5 mm.

7. A method according to claim 6 wherein said cold rolling to a second thickness is from 15% to 25% and optionally from 17 to 21% and optionally from 18% to 20%.

8. A method according to claim 1 wherein in step d the intermediate rolled product is directly cold rolled into a sheet with a thickness from 0.5 mm to 1.5 mm and in e the sheet is partially annealed at a temperature from 250° C. to 350° C.

9. A method according to claim 1 wherein the hot rolling conditions on reversible mill are adjusted to obtain a hot rolled product having, after rolling on reversible mill, a volume fraction of recrystallized grains of at least 50%, optionally of at least 80% and optionally of 100%.

10. An aluminum alloy sheet product made according to the method of claim 1.

11. An aluminum alloy sheet product according to claim 10 having, in longitudinal direction, a TYS of at least 115 MPa and optionally of at least 125 MPa, an elongation A % of at least 5% and a UTS from 135 to 185 MPa and optionally from 140 to 180 MPa.

12. An aluminum alloy sheet product according to claim 10 wherein the sheet is in a H14 temper and has, in longitudinal direction, a TYS of at least 125 MPa, an elongation A % of at least 6% and a UTS from 140 to 185 MPa and an earing percentage lower than 7% and optionally lower than 5%.

13. An aluminum alloy sheet product according to claim 10 wherein the sheet is in a H24 temper and has, in the longitudinal direction, a TYS of at least 125 MPa, an elongation A % of at least 11% and a UTS from 140 to 185 MPa and an earing percentage lower than 12%.

14. A product comprising an aluminum alloy sheet product according to claim 8 for a parallelepiped battery housing with a height of at least 70 mm, a length of at least 100 mm and a width of at least 15 mm.
